(19) United States
(12) Patent Application Publication
(10) Pub. No.: US 2002/0064631 A1
(43) Pub. Date: May 30, 2002

(54) INK JET RECORDING MEDIUM AND INK JET RECORDING METHOD EMPLOYING IT

(76) Inventors: MASAKO WAKABAYASHI, YOKOHAMA-SHI (JP); NOBUYUKI YOKOTA, YOKOHAMA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 08/691,921

(22) Filed: Aug. 1, 1996

(30) Foreign Application Priority Data
Aug. 4, 1995 (JP) 199615/1995

(51) Int. Cl. B41M 5/00

(52) U.S. Cl. 428/195

(57) ABSTRACT

An ink jet recording medium comprising a substrate having ink absorptivity and a porous ink-receiving layer formed on the substrate, wherein the substrate has pores having pore radii not larger than 3 times of the average pore radius of pores in the ink-receiving layer, in a volume per unit area of the substrate of from 2 to 1,000 cm³/m².

The present invention relates to an ink jet recording medium and an ink jet recording method employing it.

In recent years, reflecting wide use of office appliances such as electronic still cameras and computers, the hard copy technology to record images thereof on paper sheets has been rapidly developed. As hard copy recording systems, various systems have been known including not only the system wherein a display indicating an image is directly photographed by silver halide photography, but also a sublimation type thermal transfer system, an ink jet system, and an electrostatic transfer system.

An ink jet system printer has been widely used in recent years, since full coloring is thereby easy, and the printing noise is thereby low. The ink jet system is a system wherein ink liquid drops are ejected at a high speed from nozzles to a recording material, and the ink contains a large amount of a solvent. Therefore, the recording material for an ink jet printer is required to swiftly absorb the ink and have excellent color density. In such a case, with usual paper, no adequate resolution or color density is obtainable, and accordingly, it is necessary to use a recording sheet or recording medium having an inorganic porous layer formed on a substrate. For example, a recording sheet having an ink-receiving layer made of pseudo-boehmite, formed on a substrate, has been known (e.g. Japanese Unexamined Patent Publications No. 276670/1990 and No. 276671/1990).

In a case where a porous ink-receiving layer made of the above-mentioned pseudo-boehmite is formed on a substrate having no ink absorptivity, such as a polyethylene terephthalate (PET) film, such an ink-receiving layer is required to have by itself a pore volume corresponding to the mount of ink printed per unit area. Accordingly, the ink-receiving layer is usually required to have a coated amount of at least 20 g/m² for a usual printer, although the coated amount may depend also on the pore characteristics. In a case where the amount of ink is large, a larger coated amount will be required. Consequently, the recording material tends to be expensive also from the production cost. Accordingly, in order to attain cost down and high image quality, it would be one of solutions to employ a substrate having good ink absorptivity. However, even if the above-mentioned pseudo-boehmite layer is formed on a substrate having good absorptivity like a foam paper, no substantial improvement in the absorptivity has been obtained. Accordingly, it has been impossible to substantially improve the absorptivity with high color density or to reduce the coated amount of the pseudo-boehmite layer, as compared with a case where a PET film is used as the substrate, and it has not been possible to reduce the cost as expected.

Under these circumstances, it is an object of the present invention to provide an ink jet recording medium having high color density and good ink absorptivity with the same coated amount of the ink-receiving layer. In other words, it is an object of the present invention to provide an ink jet recording medium having a smaller coated amount of the ink-receiving-layer with a recording medium having the same color density and ink absorptivity.

It has been found that the above object of the present invention can be accomplished by an ink jet recording medium having a porous ink-receiving layer formed on a substrate having ink absorptivity, wherein the substrate has pores having pore radii larger than 5 times of the average pore radius of pores in the ink-receiving layer, in a volume per unit area of the substrate of from 2 to 1,000 cm³/m².

It has been found that if the pore radii of the substrate having the ink-receiving on its surface, is extremely large as compared with the average pore radius of the ink-receiving layer, the capillary tube force of the ink-receiving layer substantially exceeds the capillary tube force of the substrate, whereby the ink tends to hardly transfer from the ink-receiving layer to the substrate. It has been found that this is the reason why the ink absorptivity does not substantially increase when a usual foam paper or the like is used as the substrate as mentioned above.

Therefore, in the present invention, as the substrate, one having pores with pore radii not larger than 3 times of the average pore radius of pores in the ink-receiving layer, is used. It is preferred to use a substrate having pores with pore radii within a range of from 5 to 30 nm. Pores in the substrate having ink absorptivity are interconnected one another and are open to the surface of the substrate. If the substrate has excessively large pore radii as compared with the ink-receiving layer, such is not desirable since transfer of ink from the ink-receiving layer to the substrate tends to be poor. It has been found that in the present invention, it is particularly preferred that the substrate has pores having substantially the similar pore distribution as the ink-receiving layer, since the substrate then has a capillary tube force almost equal to the ink-receiving layer, whereby ink will be readily absorbed from the ink-receiving layer to the substrate. Further, the pore volume of the substrate governs the ink absorptivity of the recording medium. In the present invention, it has been found desirable that the pore volume per unit area of the substrate is from 2 to 1,000 cm³/m², more preferably from 5 to 500 cm³/m². In the embodiments of the present invention, substrates have pores with pore radii not larger than 2 times of the average radius of pores in the ink-receiving layer, in a volume per unit area of the substrate of from 2 to 40 cm³/m².

The substrate to be used in the present invention may, for example, be a paper, a synthetic paper, a plastic sheet or film or a nonwoven fabric. If the substrate itself has the above-mentioned pore characteristics, it may be used as it is. As such a material, a synthetic paper disclosed in European Patent 288021 owned by PPG Industries Incorporated, may, for example, be mentioned. This is a film-form finely porous material made of polyethylene or polyolefin containing a silica filler. On the other hand, in the case of a substrate which does not have the above-mentioned pore characteristics, it is advisable to incorporate an adequate amount of inorganic fine particles into the material constituting the substrate (i.e. pulp in the case of paper, or a polymer material in the case of a nonwoven fabric or synthetic paper), so that the pore radius is controlled by such inorganic fine particles to have an average pore radius and a pore volume within the above-mentioned respective ranges. The inorganic fine particles to be contained in the substrate, may be loaded throughout the thickness direction of the substrate, or may be localized along the boundary with the ink-receiving layer.

As a method for loading inorganic fine particles to the substrate, there may, for example, be mentioned a method wherein inorganic fine particles are mixed to the pulp followed by sheeting, a method wherein a sol containing inorganic fine particles, is impregnated to paper, or a method wherein inorganic fine particles are mixed to a polymer material, and the mixture is formed into a film. As the impregnation method, a dipping method, a suction filtration method, a spraying method, or a coating method by means of a coater, may preferably be employed. The amount of inorganic fine particles to be incorporated to the substrate-forming material, is preferably from 0.1 to 85 wt %, more preferably from 1 to 80 wt %, based on the substrate.

The inorganic fine particles are preferably those having an average particle diameter of from 20 to 200 nm. Among them, those obtainable from a sol having fine particles dispersed, such as alumina sol or silica sol, are preferred. A xerogel obtainable by drying such a sol contains a large quantity of fine pores and is thus capable of presenting an adequate effect with a relatively small amount of its addition. The substrate may contain a binder component or other additive components. However, in a case where inorganic fine particles are incorporated by an impregnation method, if the viscosity of the sol increases, inorganic fine particles tend to hardly adequately penetrate into paper fibers, and in such a case, it is preferred to use a sol containing no binder component.

The porous ink-receiving layer is preferably composed of inorganic fine particles bound by a binder. As the inorganic fine particles for the ink-receiving layer, alumina hydrate is preferred. Particularly preferred is pseudo-boehmite, since it absorbs and fixes a dye well. Here, pseudo-boehmite is an agglomerate of alumina hydrate represented by a compositional formula of Al₂O₃·H₂O (n=1 to 1.5).

The binder to be used for the preparation of the porous ink-receiving layer, may be an organic material such as starch or its modified product, polyvinyl alcohol (PVA) or its modified product, a styrene-butadiene rubber (SBR) latex, and acrylonitrile-butadiene rubber (NBR) latex, polyvinyl pyrrolidone (PVP) or carboxymethyl cellulose (CMC). The binder is preferably used in an amount of from 5 to 50 wt %, more preferably from 5 to 15 wt %, of the inorganic fine particles.

If the amount of the binder is less than 5 wt %, the strength of the ink-receiving layer tends to be inadequate. On the other hand, if it exceeds 50 wt %, the ink absorptivity tends to be inadequate.

The ink-receiving layer preferably has an average pore radius of from 5 to 30 nm, more preferably from 5 to 15 nm, and a pore volume of from 0.3 to 2.0 cm³/g, more preferably from 0.5 to 1.5 cm³/g, whereby it has adequate absorptivity, and the transparency of the ink-receiving layer is good. The higher the transparency of the ink-receiving layer, the higher the color density, and the higher the quality of the image thereby obtainable.

As a method for forming the ink-receiving layer on the substrate, it is preferred to employ a method wherein a binder and a solvent are added to the inorganic fine particles to obtain a sol-state coating liquid, which is then coated on the substrate, followed by drying. It is preferred to employ an alumina sol as the starting material for inorganic fine particles, since it is thereby possible to form a pseudo-boehmite ink-receiving layer excellent in the transparency. As the coating means, a conventional coating means may suitably be employed, such as a dye coater, a roll coater, an air knife coater, a blade coater, a rod coater, a bar coater or a comma coater. A coating method such as a transfer method and a cast method, whereby the coated surface become flat, may also be employed. A coated surface may be calendered to make it flat. As the solvent for the coating liquid, a water type or a non-water type may be employed.

The coated amount of the ink-receiving layer is suitably selected depending upon e.g. the specification of the printer, and it is usually preferably from 2 to 60 g/m² in a dried state. If the coated amount is less than 2 g/m², a clear color may not be obtained, such being undesirable. If the coated amount exceeds 60 g/m², the material is consumed unnecessarily, and the strength of the ink-receiving layer tends to be low, such being undesirable. The coated amount of the ink-receiving layer is more preferably from 5 to 25 g/m².

It is preferred to provide a spherical particle layer on the above described porous ink-receiving layer, since the abrasion resistance will thereby be improved as compared with a case wherein the pseudo-boehmite porous layer is provided alone. Especially preferred is that the spherical particle layer is a silica gel layer obtained by coating a silica sol. When ink is applied, the ink passed through this silica gel layer.

Such a silica gel layer can be firmly bonded to the sheet surface by dispersing the silica sol in a binder solution preferably to obtain a sol-state coating liquid and coating the coating liquid, followed by drying. As the coating method, a conventional coating method such as a dipping method, a transfer method or a method of using a coater may appropriately be employed. It is preferred to use as a usual silica sol the one having an average particle diameter of from 5 to 200 nm, preferably from 10 to 90 nm, and a solid content concentration of from 1 to 20 wt %. As the binder to be mixed to the silica sol, the same binder as used for forming the pseudo-boehmite porous layer, may be used. However, it is particularly preferred to use a silicon-containing polymer such as a silicic acid-containing polyvinyl alcohol. The amount of the binder is preferably from 1 to 30 wt % as calculated as the solid content of the silica sol (as calculated as SiO₂).

The thickness of the silica gel layer is preferably from 0.1 to 30 μm. If the thickness of the silica gel layer is less than 0.1 μm, the effects for improving the abrasion resistance tend to be inadequate. If the thickness of the silica gel layer exceeds 30 μm, the transparency and absorptivity of the ink-receiving layer tend to be impaired.

Various additives may be incorporated to the substrate, the porous ink-receiving layer and the silica gel layer. For example, an additive for the purpose of improving durability, such as an ultraviolet absorber, an anti-fading agent, an anti-bleeding agent or an anti-yellowing agent, an additive for the purpose of improving the productivity such as a defoaming agent, a viscosity-reducing agent or a gelling agent, and an additive for the purpose of imparting an additional value, such as a fluorescent brightening agent, may be incorporated, as the case requires.

Thus, the ink jet recording medium of the present invention preferably has an amount of absorption of at least 10 cm³/m², more preferably from 10 to 500 cm³/m², for a contact time of 0.05 second as measured by a Bristow method using a water-base ink containing an organic solvent.

The measurement by the Bristow method is carried out at room temperature under atmospheric pressure. The liquid to be used, is a usual ink jet recoding ink. As the colorant, a water-soluble colorant such as a direct dye or an acid dye is employed. Usually, an organic solvent such as a polyhydric alcohol to control the viscosity or the surface tension, is usually added to an aqueous solution of such a dye to obtain an ink. In some cases, an additive such as a water-soluble polymer or a surfactant may be incorporated. The physical properties of the ink are preferably such that the viscosity is 2.5 cP, and the surface tension is 30 dyne/cm.

In the present invention, as a method for printing on the above recoding medium by an ink jet system, a usual method disclosed, for example in U.S. Pat. Nos. 4,269,891, 4,664,962 and 5,459,502 can be used.

Now, the present invention will be described in further detail with reference to Examples. However, it should be understood that the present invention is by no means restricted to such specific Examples.

### EXAMPLE 1

One side of commercially available foam paper (68 g/m²) was dipped in an alumina sol (solid content concentration: 20.7 wt %, average agglomerated particle size: 187 nm) and then dried in a few minutes in an oven of 60° C., to obtain a substrate having 15 g/m² of alumina xerogel present among pulp fibers.

On the other hand, 11 parts by weight (calculated as solid content) of polyvinyl alcohol and water were added to 100 parts by weight (calculated as solid content) of the alumina sol to prepare a coating liquid having a total solid content concentration of 16.5 wt %. This coating liquid was coated on the aside dipped in the alumina sol, of the above substrate, by means of a bar coater and dried for 5 minutes in an oven of 60° C. and then for 3 minutes in a drum dryer of 140° C. to form a pseudo-boehmite porous layer in a supported amount of 10 g/m² as dried.

Further, 11 parts by weight (calculated as solid content) of silicic acid-containing polyvinyl alcohol and water were added to 100 parts by weight (calculated as solid content) of a silica sol (average particle diameter: 45 nm) to prepare a coating liquid having a total solid content concentration of 3.0 wt %. This coating liquid was coated on the side on which the above pseudo-boehmite porous layer was formed, by means of a bar coater and dried for 5 minutes in an oven of 60° C., to form a silica gel layer in a supported amount of 0.9 g/m² as dried.

The same pseudo-boehmite porous layer as described above, was formed on a polyethylene terephthalate (PET) film, and the pore distribution was measured by a nitrogen adsorption/desorption method, whereby the average pore radius was 11 nm, and the pore volume was 0.9 cm³/g. Further, with respect to the above substrate alone, the pore distribution was measured by nitrogen adsorption/desorption method using the analyzer (OMNI SORP, tradename manufactured by Coulter Co. Ltd.), whereby the volume of pores having pore radii not larger than 33 nm, per unit area of the substrate was 14 cm³/m², and the volume of pores within a range of from 5 to 30 nm which are not larger than 33 nm, per unit area of the substrate, was 10 cm³/m². Further, the volume of pores having pore radii not larger than 22 nm, per unit area of the substrate, was 14 cm³/m².

### EXAMPLE 2

A recording medium was prepared in the same manner as in Example 1 except that in Example 1, commercially available synthetic paper having pores (TESLIN, tradename, for a film-form finely porous material made of a polyethylene containing silica and having a thickness of 178 μm, manufactured by PPG Industries Incorporated) was used as the substrate. However, the supported amount of the pseudo-boehmite as dried was 10 g/m², and the supported amount of the silica gel as dried was 0.9 g/m². Further, in the same manner, with respect to the substrate alone, the pore distribution was measured by a nitrogen adsorption/desorption method, whereby the volume of pores having pore radii within a range of from 5 to 30 nm which are not larger than 33 nm, per unit area of the substrate, was 93 cm³/m². The volume of pores having pore radii not larger than 33 nm was 96 cm³/m².

### EXAMPLE 3

A recording medium was prepared in the same manner as in Example 2 except that in Example 2, no silica gel layer was formed. However, the supported amount of pseudo-boehmite as dried was 2 g/m².

### EXAMPLE 4

### Comparative Example

A recording medium was prepared in the same manner as in Example 1 except that in Example 1, no dipping treatment with the alumina sol was carried out, and the alumina sol coating liquid was directly coated on the foam paper to form a pseudo-boehmite porous layer. However, the supported amount of pseudo-boehmite as dried was 10 g/m², and the supported amount of silica gel as dried was 0.9 g/m². Further, in the same manner, with respect to the substrate alone, the pore distribution was measured by a nitrogen adsorption/desorption method, whereby both the volume of pores having pore radii not larger than 33 nm and a range of from 5 to 30 nm which are not larger than 33 nm, per unit area of the substrate, were 1.6 cm³/m².

### EXAMPLE 5

### Comparative Example

In Example 2, only the substrate was used without forming the pseudo-boehmite layer and the silica gel layer.

Printing Evaluation

On the pseudo-boehmite-coated side of each of the recording media of Examples 1-4 and on the substrate of Example 5, color printing was applied by an ink jet printer (MJ-5000C, tradename, manufactured by Seiko Epson K.K.), whereby the ink absorptivity was qualitatively evaluated. For the evaluation, a pattern of printing fine letters in magenta was used with a background of dark blue (mixed color of cyan and magenta). If the absorptivity of a recording medium is inadequate, magenta tends to run from the fringe of the blue background, or blue tends to run to the magenta letter portions. As a result of printing evaluation, no running was observed with the recording media of Example 1, 2, 3 and 5, but substantial running was observed with the medium of Example 4.

Measurement of Color Density

With respect to a recorded image formed by printing on the pseudo-boehmite coated side of each of the recording media of Examples 1-4 and on the substrate of Example 5 by an ink jet printer, the color density was measured by means of a color density meter (SPM100-II, tradename, manufactured by GRETAG company). The results are shown in Table 1. Usually, a clear image can be obtained, when the color density is at least 1.5.

Measurement of Absorbed Amount

By means of a Bristow method tester (No. 207, tradename, manufactured by Kumagaya Riki Kogyo K.K.), the amount of absorbed liquid was measured at room temperature under atmospheric pressure using cyan ink (MJIC2C, tradename, manufactured by Seiko Epson K.K.) which was used for printing evaluation. From the liquid absorption curve, the amount of absorbed liquid at the contact time of 0.05 second was determined. The results are shown in Table 1.

With respect to the cyan ink used for the printing evaluation and the measurement of the amount of absorbed liquid, the viscosity and the surface tension were measured at room temperature by means of a viscometer (LVF, tradename, manufactured by Brookshield Engineering Laboratories, Inc.) and a surface tension meter (ESB-V, tradename, manufactured by Kyouwa Kagaku K.K.), whereby the viscosity was 2.5 cP, and the surface tension was 30 dyne/cm.

TABLE 1

| | | | Amount of |
|---|---|---|---|
| | | | absorbed |
| | | | liquid |
| | | | (cm³/cm²) |
| | | | Contact |
| | Printing | Color | time |
| Sample | evaluation | density | 0.05 (s) |
| Example 1 | ◯ | 2.2 | 12 |
| Example 2 | ◯ | 2.2 | 13 |
| Example 3 | ◯ | 2.1 | 12 |
| Example 4 | X | 2.1 | 9 |
| Example 5 | ◯ | 0.8 | 18 |

The ink jet recording medium of the present invention absorbs ink swiftly and is excellent in the color density, whereby no running of ink is observed, and the printed image is clear.

What is claimed is:

1. An ink jet recording medium comprising a substrate having ink absorptivity and a porous ink-receiving layer formed on the substrate, wherein the substrate has pores having pore radii not larger than 3 times of the average pore radius of pores in the ink-receiving layer, in a volume per unit area of the substrate of from 2 to 1,000 cm³/m².

2. The recording medium according to claim 1, wherein the substrate has pores having pore radii within a range of from 5 to 30 nm.

3. The recording medium according to claim 1, wherein the substrate has pores having pore radii not larger than 2 times of the average pore radius of pores in the ink-receiving layer, in a volume per unit area of the substrate of from 2 to 40 cm³/m².

4. The recording medium according to claim 1, wherein the substrate is a cellulose paper having inorganic particles incorporated in an amount of from 0.1 to 85 wt %.

5. The recording medium according to claim 1, wherein the substrate is a synthetic paper.

6. The recording medium according to claim 1, wherein the ink-receiving layer has pores having an average pore radius of from 5 to 30 nm in a volume per unit weight of from 0.3 to 2.0 cm³/g.

7. The recording medium according to claim 1, wherein the ink-receiving layer is made of alumina hydrate.

8. The recording medium according to claim 1, which has a layer of spherical particles having an average particle diameter of from 5 to 200 nm, on the ink-receiving layer.

9. The recording medium according to claim 1, wherein the spherical particle layer on the ink-receiving layer is a silica gel layer.

10. The recording medium according to claim 1, which has an amount of absorption of at least 10 cm³/m² for a contact time of 0.05 sec as measured by Bristow method employing a water-base ink with a viscosity of 2.5 cP and a surface tension of 30 dyne/cm.

11. An ink jet recording method, which comprises applying ink jet printing on the recording medium as defined in claim 1 by using a water-base ink with a viscosity of 2.5 cP and a surface tension of 30 dyne/cm.

12. The recording method according to claim 11, wherein the dye in the water-base ink is a direct dye or an acid dye.
